(19) United States
(12) Patent Application Publication
(10) Pub. No.: US 2017/0065131 A1
(43) Pub. Date: Mar. 9, 2017

(54) COOKING ASSISTANT

(71) Applicants: Robert Rife, Mt. Pleasant, SC (US); Sarah Richards, Charleston, SC (US)

(72) Inventors: Robert Rife, Mt. Pleasant, SC (US); Sarah Richards, Charleston, SC (US)

(21) Appl. No.: 15/259,192

(22) Filed: Sep. 8, 2016

Related U.S. Application Data
(60) Provisional application No. 62/215,210, filed on Sep. 8, 2015.

(51) Int. Cl. A47J 45/02; F16B 2/06; A47J 45/10; F16B 1/00; F16M 13/02

(52) U.S. Cl. CPC A47J 45/02; F16B 1/00; F16M 13/022; A47J 45/10; F16B 2/065; F16B 2001/0035

(57) ABSTRACT

A cooking assistant for holding items used while cooking has a generally vertical member that is held on a cooktop by a magnet. A member extending downwardly from the generally vertical member has a cradle formed at a lower portion of the downwardly extending member. A tray engages the generally vertical member between the magnet and the cradle. A C-clamp may be mounted over the magnet to secure the device to a countertop.

Applicant claims the benefit of Provisional Application Ser. No. 62/215,210 filed Sep. 8, 2015.

### FIELD OF THE INVENTION

This invention relates to cooking and kitchen devices generally, and is more specifically related to a holder for kitchen devices and materials.

### BACKGROUND OF THE INVENTION

Pots and pans are used on cooktops while cooking. Other utensils and devices are used in connection with pots and pans on cooktops. For example, spoons are used to stir contents of a pot or pan. A lid must be removed from a pot or pan for stirring or otherwise manipulating the contents of the pot or pan, or for adding additional ingredients during the cooking process.

It can be problematic to temporarily reposition lids of pots and pans and to position spoons or other utensils after use. This is especially true when spoons or utensils are to be used again, since the spoons or utensils have been exposed to the contents of the pan. Repositioning of lids, spoons and other utensils results in a mess on and around a cooktop and kitchen counters.

### SUMMARY OF THE INVENTION

A cooking assistant for holding items used while cooking has a generally vertical member that is held on a cooktop by a magnet. A member extending downwardly from the generally vertical member has a cradle formed at a lower portion of the downwardly extending member. A tray engages the generally vertical member between the magnet and the cradle. A C-clamp may be mounted over the magnet to secure the device to a countertop.

### BRIEF DRAWING DESCRIPTION

FIG. 1 shows a device according to the invention positioned on a cooktop, with a spoon and a pan lid positioned within the device.

FIG. 2 illustrates a preferred embodiment of the device according to the present invention.

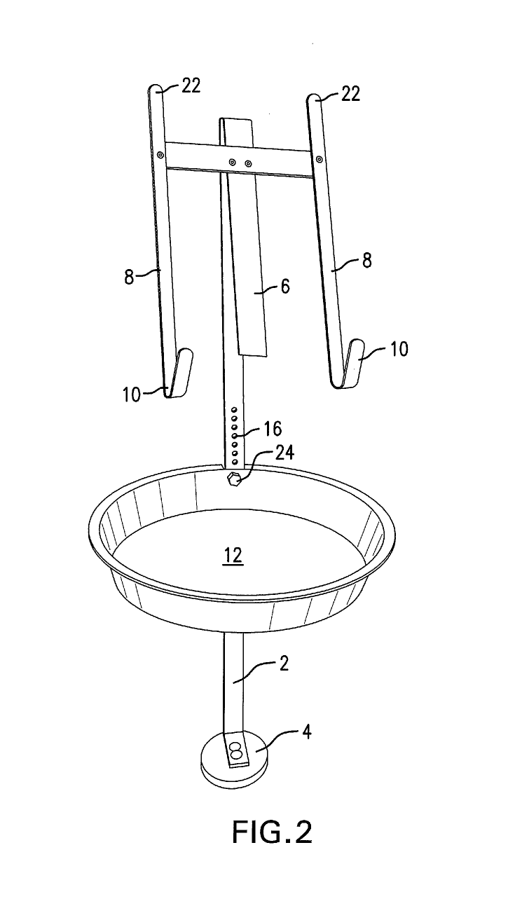

FIG. 3 shows another embodiment of the device with spoons positioned in the device and a pot lid positioned in the device.

FIG. 4 shows a side elevation of the device according to an embodiment of the invention.

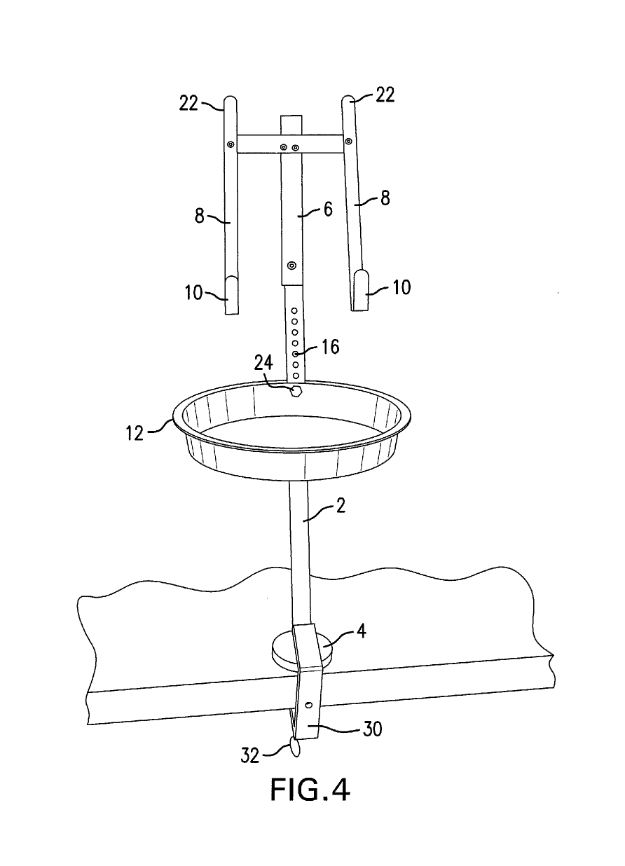

### DESCRIPTION OF PREFERRED EMBODIMENTS

According to a preferred embodiment of the device, the stand of the cooking assistant comprises a generally upright or vertical member 2. In a preferred embodiment, a magnet 4 is attached to the device at a lower end thereof. The generally vertical member is preferred to have a height of not less than five (5) centimeters.

The generally vertical member 2 transitions at an upper end to form a downwardly extending member 6 that is connected to or extends from the generally vertical member, and extends down and away from the vertical member at an angle, which may be an angle of fifteen (15°) degrees to seventy five (75°)degrees, and more preferably, an angle of about thirty (30°) degrees to sixty degrees (60°) degrees from vertical. The downwardly extending member is preferred to have a length of not less than two and one half (2.5) centimeters. The downwardly extending member may comprise two spaced apart members 8 that may be generally parallel to each other.

A cradle or cradles 10 may be formed on the end of the downwardly extending member of the frame of the device. The cradles may form upwardly extending hooks on one end. The cradle or cradles are constructed and arranged so that pan lids or other kitchen tools and utensils may rest within the cradle or cradles, or be hung from the hooks formed by the cradles. The cradle or cradles may be arcuate members that open on an upper side.

An upper end 22 of the downwardly extending member is preferred to extend above the generally vertical member 2. The parallel members 8 may form the upper end or ends 22. The upper ends may be used as points to hang kitchen utensils and other articles so that they are conveniently positioned for use.

A receptacle 12 such as a tray is positioned between the base and the lower end and the cradle. The receptacle is attached to the generally vertical member. The attachment may be fixed, such as by welding or attaching the receptacle to the vertical member with a rivet or other fastener. The receptacle is located underneath the cradle or cradles to catch material that drips from objects such as pot or pan lids that are positioned within and held within the cradles. It is preferred that the receptacle is not less than 30 cm from the bottom of the magnet to the bottom of the receptacle.

It is preferred that the receptacle engage the generally vertical member in a selectively adjustable fashion, such as by providing a series of voids 16 that a fastener such as pin 24 engages. In another embodiment a collar or slide attached to a side of the receptacle engages the generally vertical member. A lock may be provided to secure the receptacle in place relative to the generally vertical member. An example of a lock is a thumbscrew. The collar or slide may be attached to the receptacle and the thumbscrew may extend through the collar to contact the receptacle in a threaded engagement. The thumbscrew is tightened in the threaded engagement, and the receptacle is held in a static position relative to the vertical member. A thumbscrew may act as pin 24

In another embodiment, the receptacle is attached to the vertical member, and the vertical member is a telescoping member, so that the position of the receptacle relative to the base at the lower end of the vertical member may be moved upwardly and downwardly by telescoping the generally vertical member and locking the position of the telescoping member as telescoping devices are known to lock.

In use, the magnetic base is positioned on a cooktop or stove top 16 having a ferrous component, which is common with range tops and stove tops (“cooktops”). The magnetic base 4 firmly attaches to the cooktop to hold the device firmly in place while being removable by manual force. It is preferred that not less than 2 pounds of force will break the magnet from the cooktop, and more preferably, that less than 3 pounds of force is required to break the magnet away from the cooktop.

The magnet is preferred to be as small as possible while providing the necessary support for the device plus any objects that may be positioned within the device. The magnet should be capable of fitting between burners of stoves or ranges in common use. A small size also permits the device of the invention to be moved close to a pot or pan on a burner, so that the receptacle can be positioned over the pot or pan if desired, although such positioning is not always required. In one embodiment, the magnet has a diameter of not less than 2.5 inches.

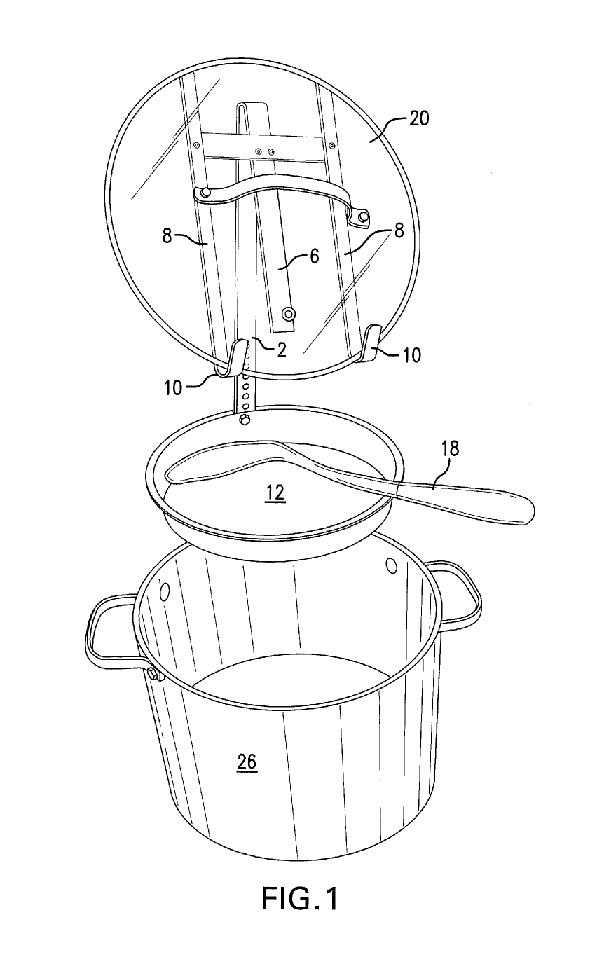

As shown in FIG. 1, the receptacle 12 may be positioned over a cooking pan or pot 26. A spoon 18 may be positioned in the receptacle. The spoon or other cooking utensil is conveniently positioned for cooking operations on the cooktop, and is available for use as needed. At the same time, any food matter, water or other liquids that are attached to the spoon are prevented from dripping away from the spoon and onto the cooktop or other surfaces by the receptacle that is positioned underneath the cradles 10 at the lower end of the downwardly extending member.

The receptacle is preferred to be positioned high enough relative to the vertical member so that a cooking pan or cooking pot may be positioned under the receptacle. It is preferred that the bottom of the receptacle is not less than 5 cm above the cooking pan or pot. It is also preferred that the bottom of the receptacle is 3 to 10 cm below the bottom of the cradle. When the receptacle is positioned over the cooking pan or cooking pot, there is little chance for undesired materials dripping or falling from objects held in the cradle or cradles to create a mess on the stove or nearby countertop.

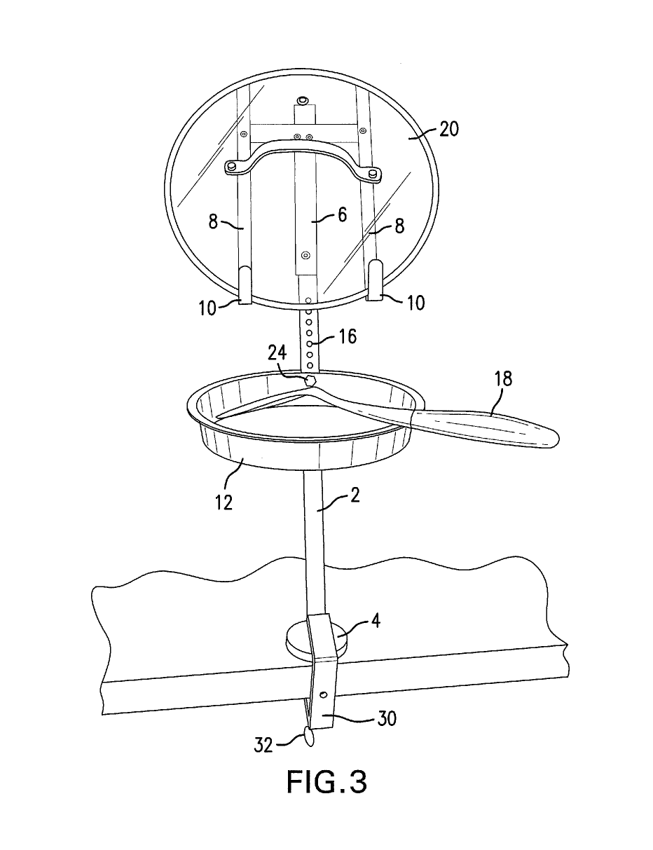

Similarly, the pan lid or pot lid 20 may be positioned in the cradle as shown in FIGS. 1 and 3. Any condensation or food matter that has accumulated on the lid will drip or fall into the receptacle, and is retained by the receptacle.

It is preferred that the receptacle is easily removed from the generally vertical member, such as by the use of a pin attachment. In this way, the receptacle, which is most likely to be soiled, can be easily removed for placement in a dishwasher without having to place the entire apparatus in a dishwasher.

A C-clamp 30 may be provided for clamping the base at the lower end of the vertical member to countertops, which generally do not have a ferrous component to which the magnet will attach. The C-clamp is positioned over the magnet, and is preferred to have a ferrous component so that the C-clamp is held against the magnet by magnetic force. A fastener such as a thumbscrew 32 in the lower portion of the C-clamp secures the C-clamp in place.

The device may be easily moved from one location on a cooktop to another location on the cooktop by use of the magnetic base. The device frees up counter space, and eliminates a common problem of dripping of food matter as a spoon, pan top or other kitchen utensil or tool is moved from a location on the cooktop to the counter.

What is claimed:

1. A cooking assistant, comprising:
a generally vertical member, a magnet positioned at a lower end of the generally vertical member, the magnet constructed and arranged to mount to a cook top comprising a ferrous component and requiring not less than two (2) pounds of force to break the magnet from the cook top;
a downwardly extending member extending downwardly from an upper portion of the generally vertical member at an angle of fifteen (15°) degrees to seventy five (75°) degrees from vertical, the downwardly extending member having a cradle formed at a lower portion of the downwardly extending member;
a tray that engages the generally vertical member between the magnet and the cradle mounted on the generally vertical member and underneath the cradle.

2. The cooking assistant described in claim 1, further comprising a C-clamp that mounts over the magnet.

3. The cooking assistant described in claim 1, further comprising a C-clamp that mounts over the magnet, wherein the C-clamp is held in position on the cooking assistant by magnetic attraction to the magnet.

4. The cooking assistant described in claim 1, wherein the downwardly extending member comprises two (2) generally parallel legs, and wherein the cradle is formed by an arcuate member formed on each of the generally parallel legs near a lower portion of the generally parallel legs.

5. The cooking assistant described in claim 1, wherein the generally vertical member is constructed and arranged to accept and hold the tray at multiple vertical positions on the generally vertical member.

6. The cooking assistant described in claim 1, wherein the cradle is constructed and arranged for receiving and holding a generally circular pan lid.

7. The cooking assistant described in claim 1, wherein the downwardly extending member extends downwardly from the upper portion of the generally vertical member at an angle of thirty degrees (30°) to sixty (60°) degrees from vertical.

8. The cooking assistant described in claim 1, wherein the downwardly extending member extends above a top of the generally vertical member.

9. The cooking assistant described in claim 1, wherein the magnet is constructed and arraigned to fit between burners of a cooktop.

10. The cooking assistant described in claim 1, wherein the magnet is constructed and arranged to fit between burners of a cooktop, the receptacle is positioned on the generally vertical member not less than 30 cm from the bottom of the magnet to the bottom of the tray, and the bottom of the receptacle is not less than 3 cm from the bottom of the receptacle.
